(19) United States
(12) Patent Application Publication
(10) Pub. No.: US 2008/0231136 A1
(43) Pub. Date: Sep. 25, 2008

(54) ELECTRICAL ROTATING MACHINE AND ELECTRIC VEHICLE

(76) Inventor: Koji OBATA, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/019,662

(22) Filed: Jan. 25, 2008

(30) Foreign Application Priority Data
Mar. 22, 2007 (JP) 2007-073852

(51) Int. Cl. H02K 3/40; H02K 3/32

(52) U.S. Cl. 310/179; 310/196

(57) ABSTRACT

An electrical rotating machine wherein the coil end portion and slot straight portion of a coil conductor are coated with insulation layers respectively. The insulation layers are different in thickness or insulation material, and an electric field lessening layer is coated on the coil conductor or the insulation layers.

### CLAIM OF PRIORITY

The present application claims priority from Japanese application JP 2007-073852 filed on Mar. 22, 2007, the content of which is hereby incorporated by reference into this application.

### BACKGROUND OF THE INVENTION

1. Field of the Invention

The present invention relates to an electrical rotating machine.

2. Description of the Related Art

Demands for higher output power density in vehicles and general industrial electrical rotating machines have been increasing. In particular, for vehicles, the electrical rotating machine is not only a driving power but also itself a load, and hence higher output power density is required of the electrical rotating machine to improve fuel economy and mileage.

There are two kinds of ways for achieving higher output power density in electrical rotating machines. One way is to make an electrical rotating machine smaller and to increase its output power. As to making the machine smaller, there is known a way which improves the occupancy of a winding (the occupancy by conductors in the slot) in electrical rotating machines by making use of square shape wires and a method which makes coil ends (on opposite sides of the core of an electrical rotating machine) compact. As to increasing the output power, a way is known which makes higher electrical rotating machine's rated voltage, current higher, and rotation speed. Conventionally, making the electrical rotating machine smaller and increasing the output power have been separately considered. However, in order to further increase output power density of electrical rotating machines, both making the electrical rotating machine smaller and increasing the output power need to be achieved at the same time.

Examples of making an electrical rotating machine smaller by making use of square shape wires are described in Japanese Patent Application Laid-Open Publications No. 2005-20943 (reference 1) and No. 2002-209355 (reference 2). In the conductor crossover portion at each coil end of the electrical rotating machine, conductors are insulated from each other by inserting a sheet of insulation paper sheet in the case of reference 1, and by making resin cover the conductors by immersion or coating in the case of reference 2. In both cases, the conductor turns in the slot are insulated from each other by the insulation film covering the wire conductor.

However, in order to insulate conductors, i.e. partial coils, at the coil end portion with a sheet of insulation paper, the sheet of insulation paper is inserted into spaces while the partial coils are not connected, and then the partial coils are connected to each other by welding. Hence, there is a problem that the sheet of insulation paper may be conductive after burned to be carbonized due to heat generated by the welding.

Further, the sheet of insulation paper has to be inserted manually, and hence there is another problem that work efficiency is poor and that variation in insulation property is large. As a result, insulation failed units are produced. Meanwhile, in the case of resin immersion or resin coating for insulation in the coil end portion, the coil end portion might not sufficiently be impregnated with resin because conductors at the coil end portion forming a complicated pattern are very close to each other. In particular, there is a problem that the more compact the coil end becomes, the lower the probability on the coil end portion being fully impregnated with resin.

Hence, although having no problem at rated voltages of about several v to several tens of V, conventional low voltage electrical rotating machines using square shape wires are difficult to achieve higher rated voltages and higher output power to become on demand in the future.

Further, in recent years, as an electrical rotating; machine is often operated at various speeds making use of an inverter, surge voltages generated by the inverter cause unexpectedly high voltages to be applied between conductor turns inside and outside the slot. These high voltages pose also a problem, which is difficult to overcome so far.

### SUMMARY OF THE INVENTION

The present invention was made to solve the above mentioned problem, and its objective is to provide an electrical rotating machine that is not only smaller but also higher in rated voltage and output power.

In the production of the electrical rotating machine of the present invention, at least a coil end portion of each partial coil is coated with an insulation layer before each partial coil is mounted in a slot, and the partial coils are connected to form a stator coil of an electrical rotating machine after mounted in the slots. In the production of the partial coil, an electric field lessening layer is formed on the coil conductor and an insulation layer is formed on the electric field lessening layer. Then, an electric field lessening layer is again formed on the insulation layer. An electric vehicle with improved fuel consumption and mileage can be realized by mounting the electrical rotating machine of the present invention therein.

### BRIEF DESCRIPTION OF THE DRAWINGS

For a more complete understanding of the present invention and its advantages, reference is now made to the following description taken in conjunction with the accompanying drawings wherein:

FIG. 1 shows a partial coil of an electrical rotating machine according to the first embodiment;

FIG. 2 shows a way to mount the partial coil of the electrical rotating machine in slots according to the first embodiment;

FIG. 3 shows a stator core having partial coils of the first embodiment mounted in its slots;

FIG. 4 shows an example where an insulation layer of slot straight portions has been formed in steps according to the first embodiment;

FIG. 5 shows a partial coil of an electrical rotating machine according to the second embodiment;

FIG. 6 shows a partial coil of an electrical rotating machine according to the third embodiment;

FIG. 7 shows a coil of an electrical rotating machine according to the fourth embodiment;

FIG. 8 shows a coil end of an electrical rotating machine of comparative example 1;

FIG. 9 shows the voltage application rate between coil turns when a precipitous surge voltage from an inverter is applied to the coil of the first embodiment and a conventional coil;

FIG. 10 shows a circuit used to measure the voltage share;

FIG. 11 shows an example of waveforms when the voltage share is measured;

FIG. 12 shows schematically electric potential distribution in the coil end of the first embodiment;

FIG. 13 shows an example where the electrical rotating machine of the first embodiment is used as a motor generator;

FIG. 14 shows an electric drive system of a hybrid electric vehicle; and

FIG. 15 shows the circuit configuration of an inverter.

### DETAILED DESCRIPTION OF THE INVENTION

Embodiments of the present invention will be described below using the drawings. The present invention relates to the insulation of low voltage electrical rotating machines and particularly to the insulation of low voltage electrical rotating machines of 600 V rms class or below which use square shape wires as winding conductors.

### First Embodiment

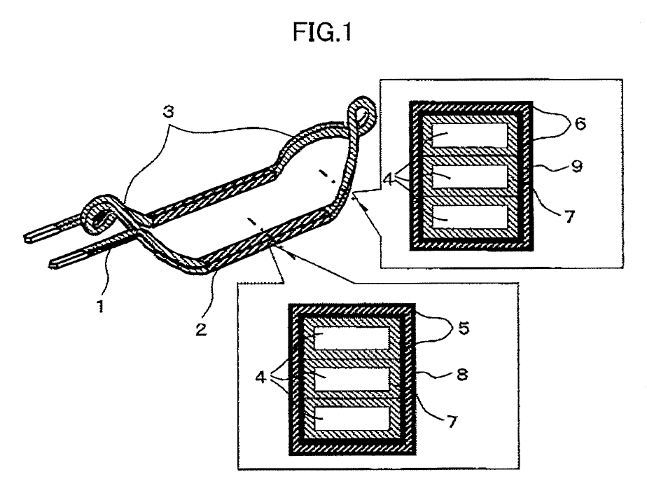

FIG. 1 shows a partial coil of an electrical rotating machine of the first embodiment. An electrical rotating machine coil 1 is made by covering with an electric field lessening layer 5 or 6 a coil conductor formed by winding a wire conductor 4 on itself a predetermined number of times, and then coating slot straight portions 2 of the coil conductor with an insulation layer 8 and coil end portions 3 of the coil conductor with an insulation layer 9, and finally coating them again with an electric field lessening layer 5 or 6.

An insulation film 7 over the wire conductor 4 can be such an enamel film as made of polyamide-imide, polyester imide, polyimide, polyester, and polyethylene naphthalate, or an enamel film containing inorganic fillers, or a impregnated glass fiber film with alkyd resin or the like. The electric field lessening layers 5 and 6 can be made of resin of epoxy, polyester, or acryl which contains such conductive or semiconductive fillers as made of carbon, iron, asbestos, or SiC, or a conductive high polymer. The insulation layers 8, 9 can be formed by winding a tape made of glass fibers, alumina fibers, or polyamide-imide fibers around the coil conductor or by winding the tape impregnated with resin such as epoxy resin, polyester resin, phenol resin, or silicone resin, or by winding a film made of polyimide, polyester, or polyethylene naphthalate, or by directly coating, spraying, or molding resin such as epoxy resin, polyester resin, phenol resin, or silicone resin.

The thickness of the insulation layer 8 of the slot straight portions 2 is determined such that a partial discharge start voltage of the slot straight portion 2 is higher than the peak voltage against the to-ground voltage during the operation of the electrical rotating machine and also that a dielectric breakdown does not occur even in the withstand voltage test of 2E+1, where E is a predetermined rated voltage. Meanwhile, the thickness of the insulation layer 9 of the coil end portions 3 is determined such that a partial discharge start voltage of the coil end portion 3 is higher than the peak voltage of between-phase voltage during the operation of the electrical rotating machine and also that a dielectric breakdown does not occur even at test voltages of an impulse withstand voltage test. The thickness of the insulation film 7 insulating the turns from each other is set such that a partial discharge start voltage between the turns is higher than between-turn voltage during the operation of the electrical rotating machine and also that a dielectric breakdown does not occur even at test voltages of an impulse withstand voltage test.

One feature of the present invention is that the slot straight portion and the coil end portion are designed to be different in the thickness of the insulation layer from those in the large-scale electrical rotating machines. With this feature present, there is provided an electrical rotating machine that is not only smaller but also higher in voltage and output power.

Moreover, while in conventional electrical rotating machines the electric field lessening layer is provided on only the slot straight portion, in the present invention the electric field lessening layer is provided on the coil end portion as well, which is another feature of the present invention. Making use of this feature, the coil end can be made smaller.

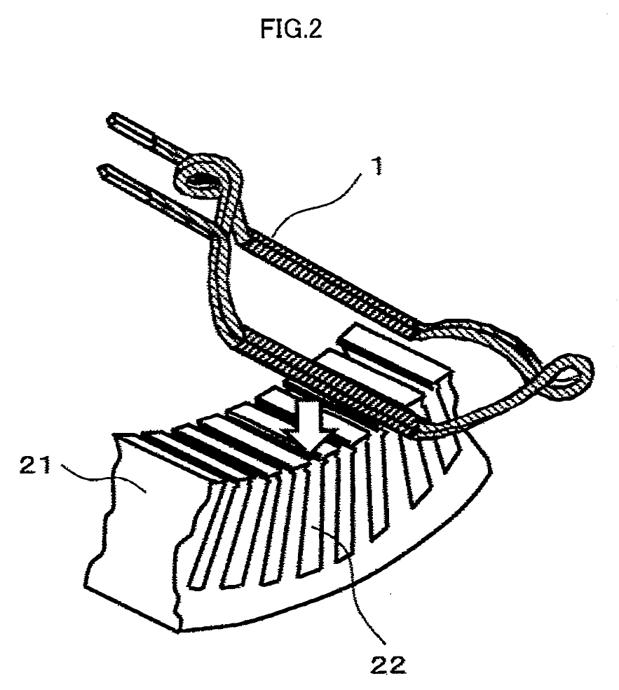

FIG. 2 shows a method of mounting the electrical rotating machine coil 1 of the first embodiment into a slot. The electrical rotating machine coil 1 is pushed from the inner radius side of a stator core 21 into a slot 22 to be mounted therein. A laminated steel plate in which silicon steel plates or amorphous steel plates are laid one on top of another, or a dust core molded by compressing iron powder or insulation-coated iron powder can be used as the stator core 21. In the first embodiment, the partial coils are mounted in the stator core, thereby making a stator coil, but the partial coils can be mounted in a rotor core, thereby making a rotor coil.

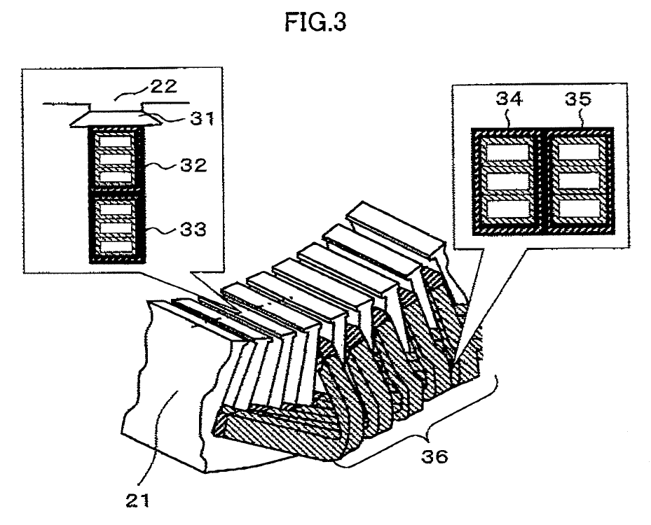

FIG. 3 shows the stator core 21 having the electrical rotating machine coils of the first embodiment mounted in its slots, which form a stator coil 36. In the slot 22, two stator partial coils, i.e., an upper coil 32 and a lower coil 33 are inserted, and a wedge 31 is inserted to fix the coils. The upper coil 32 and the lower coil 33 are insulated from each other, and each coil and the stator core 21 are insulated from each other by the insulation layer 8 of FIG. 1. The turns are insulated from each other by the insulation film 7 of the wire conductor 4 of FIG. 1.

Meanwhile, at the coil end, stator partial coils adjacent in the circumferential direction or the radial direction are in contact with each other. FIG. 3 shows stator partial coils 34, 35 adjacent in the circumferential direction being in contact. The stator partial coils 34 and 35 are insulated from each other by the insulation layer 9 of FIG. 1.

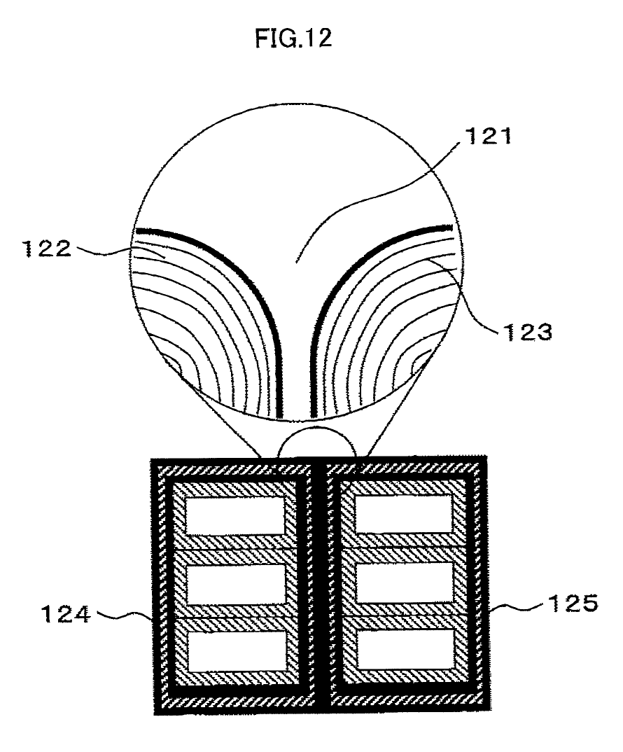

FIG. 12 shows schematically electric potential distribution in the coil end of the first embodiment. A potential difference exists between adjacent partial coils 124 and 125. Hence, a potential gradient occurs in the insulation layer of the adjacent partial coils as indicated by equipotential lines 122, 123. However, in the first embodiment, since no equipotential line exists in air 121 between the adjacent coils, the air, which is low in dielectric breakdown strength, does not break down, i.e., does not allow a partial discharge. Thus, partial discharge degradation does not occur.

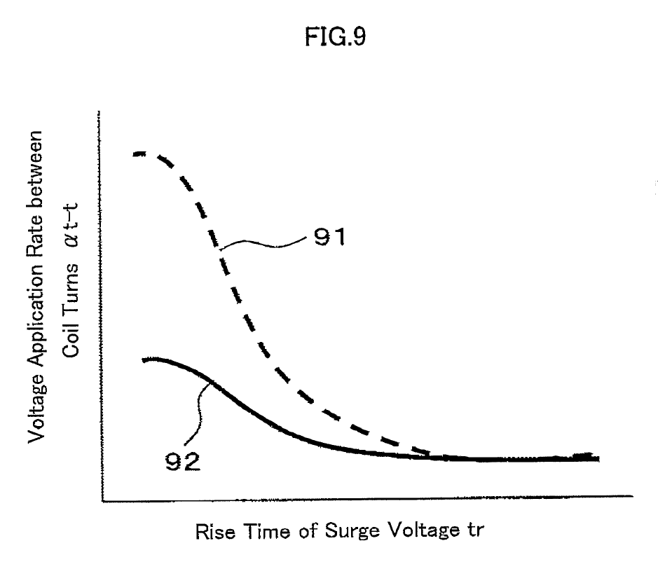

FIG. 9 shows the voltage application rate between coil turns when a precipitous surge voltage from an inverter is applied to the coil of the first embodiment and a conventional coil. The horizontal axis represents the voltage rise time of the surge voltage, and the vertical axis represents the voltage share. The voltage share of the coil of the first embodiment is indicated by reference numeral 92, and that of the conventional coil is numeral 91. As the rise time of the surge voltage decreases, the voltage share 91 of the conventional coil increases. Meanwhile, the voltage share 92 of the coil of the first embodiment only slightly increases.

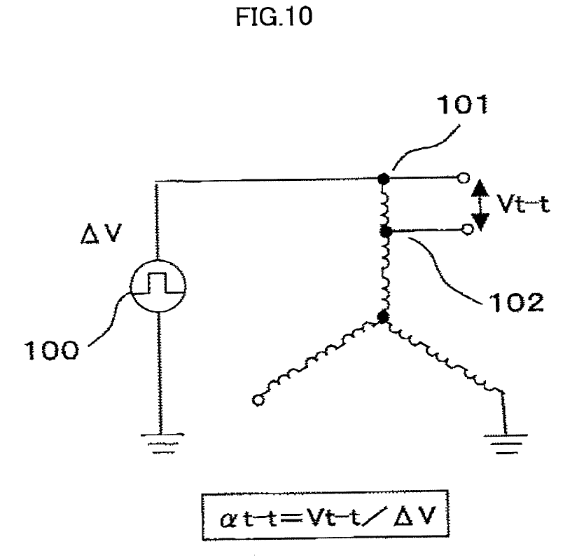

FIG. 10 shows the circuit used to measure the voltage share of FIG. 9. Having a pulse generator 100 generate a surge voltage and apply it to an electrical rotating machine, the potential difference between a lead side turn 101 and a neutral point side turn 102 is measured and divided by the applied voltage to obtain the voltage share. The voltage share against the rise time of the surge voltage is measured while changing the voltage rise time of the pulse generator 100. In this measurement, the coils of the phases other than the voltage applied phase and the core are grounded.

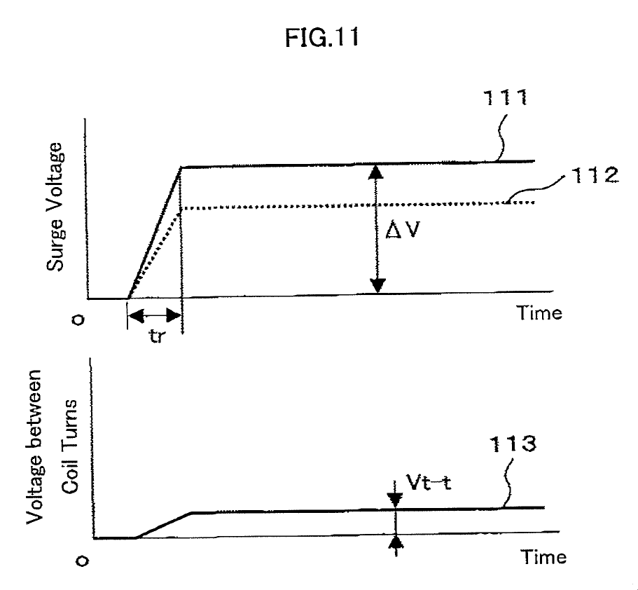

FIG. 11 shows an example of the measured waveform. The horizontal axis represents time, and the vertical axis represents voltage. By performing a waveform difference operation on the difference between the to-ground voltage 111 of the lead side turn and the to-ground voltage 112 of the neutral point side turn on a digital oscilloscope, between-turn voltage 113 can be obtained.

As described above, in the first embodiment, because the insulation layers of this invention are formed before the partial coils are inserted unlike those of a conventional low voltage electrical rotating machine using square shape wires, the burning of a sheet of insulation paper insulating the coil end portions or insulation failure due to failure in resin permeation does not occur. Further, even in the coil end where partial coils are close to each other, partial discharge degradation does not occur. Thus, there is provided an electrical rotating machine superior in insulation capability to the conventional low voltage electrical rotating machine using square shape wires, and an electrical rotating machine can be easily made higher in rated voltage and output power. Moreover, because the voltage application rate between coil turns is low, a precipitous surge voltage from an inverter can be dealt with by means of only the insulation of the wire conductor or the minor addition of the insulation films.

In FIG. 1 for the first embodiment, before the partial coils are mounted in the slots 22 of FIG. 2, all insulation layer 8 of the slot straight portion 2 is formed, but the insulation layer 8 may be formed in steps before and after the partial coils are mounted in the slots 22. As such, by forming the insulation layer of the slot straight portion in steps, scratches can be prevented from occurring when the partial coils are inserted into the slots, and the insulation thicknesses and material composition of the slot straight portion and of the coil end portion can be optimized.

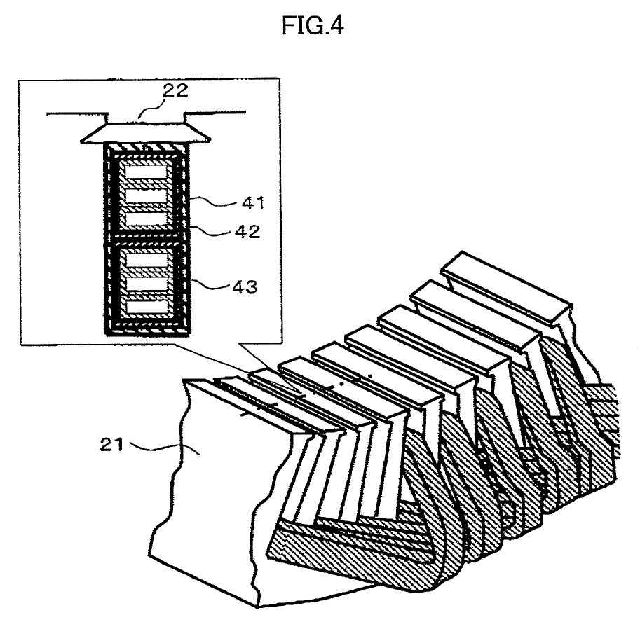

FIG. 4 shows an example where the insulation layer 8 of the slot straight portion has been separately formed. While in FIG. 1 the insulation layer 8 of the slot straight portion is as thick as the insulation layer 9 of the coil end portion 3, in FIG. 4 the slot straight portion has only the insulation film on the wire conductor 4. Shortage of the insulation thickness between the core 21 and an upper coil 41 and a lower coil 43 is compensated for by sticking a sheet of slot insulation paper 42 to the inner side of the slot 22. In this method, the electric field lessening layer 5 of FIG. 1 may be coated on the insulation layer 8 of the slot straight portion. As the sheet of slot insulation paper, a film of polyimide, polyester, polyethylene naphthalate, or the like and an impregnated film with epoxy resin, polyester resin, phenol resin, silicone resin, or the like can be used.

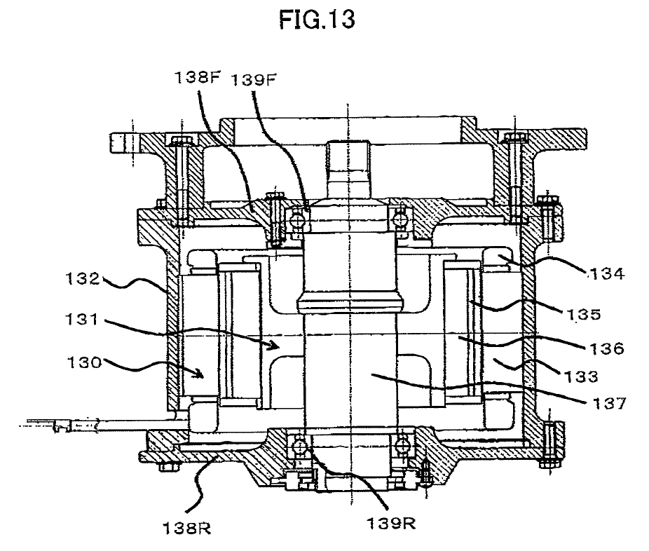

FIG. 13 shows an example where the electrical rotating machine of the first embodiment is used as a motor generator. The motor generator comprises a stator 130 and a rotor 131 rotatably supported on the inner circumference side of the stator 130 and spaced away from the stator. The stator 130 and the rotor 131 are held in a housing 132 of the electrical rotating machine.

The stator 130 comprises a stator core 133 and a stator coil 134. The stator core 133 is made up of thin steel plates press formed into a predetermined shape and laid one on top of another. The stator core 133 comprises an annular yoke core and a plurality of tooth cores arranged at an equal interval along the circumference so as to protrude in the radial direction from the yoke core and formed integrally with the yoke core. A plurality of slots, each of which extends continuously in the axial direction, are formed on the inner circumference side of the stator core 133. These slots are groove-like spaces formed between the tooth cores adjacent to each other in the circumferential direction as shown in FIG. 2. In the present embodiment, 48 slots are formed. The stator coil 134 is wound around the tooth cores of the stator core 133 in such a distributed way that its partial coil is mounted in two slots which are disposed apart from each other with a plurality of slots present between them.

The stator coil 134 is constituted by a U-phase, stator coil, a V-phase stator coil, and a W-phase stator coil that are formed by winding the wire conductor on itself several times. After wound by an automatic winding machine beforehand, the stator coil 134 is coated with an insulation layer according to the previously described, method and inserted through the openings of the slots of the stator core 133 by an automatic inserting machine. The U-phase stator coil, the V-phase stator coil, and the W-phase stator coil are inserted in that order into the slots. The coil ends of the stator coil 134 protrude from the slots in opposite axial direction so as to be located at opposite axial ends of the stator core 133.

The rotor 131 comprises a rotor core 136, permanent magnets 135 and a shaft 137. The rotor core 136 is made up of thin steel plates press formed into a predetermined shape and is fixed to the shaft 137. A plurality of magnet inserted holes extending in the direction of the axis of the rotor 131 are formed on the outer side of the rotor core 136 at an equal interval along the circumference. In the present embodiment, eight magnet inserted holes are formed. The permanent magnet 135 is inserted and fixed in each magnet inserted hole. The shaft 137 is rotatably supported via bearings 139F, 139R by end bracket 138F, 138R secured to the opposite ends of the housing 132.

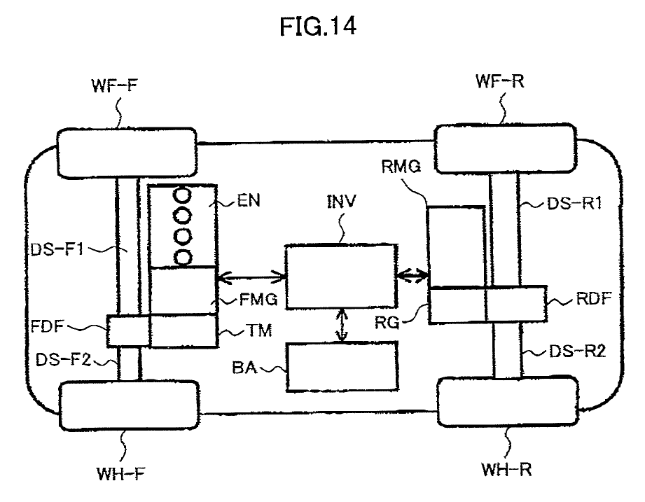

FIG. 14 shows a configuration of the electric drive system of a hybrid electric vehicles which is an electric vehicle, in which the electrical rotating machine of the first embodiment is mounted. Electric vehicles include, as well as a purely electric vehicle powered only by a secondary battery and an electrical rotating machine, a hybrid electric vehicle having an internal combustion engine, a secondary battery, and an electrical rotating machine, and a fuel cell hybrid electric vehicle having a fuel cell, a secondary battery, and an electrical rotating machine. Hereinafter, a hybrid electric vehicle having an internal combustion engine, a secondary battery, and an electrical rotating machine will be described, but in any electric vehicle the same effect can be produced. The hybrid electric vehicle is of a four-wheel drive scheme where an internal combustion engine EN and a front motor generator FMG constituted by one of the above-described electrical rotating machine, drive front wheels WH-F and a rear motor generator RMG constituted by one of the electrical rotating machine drives rear wheels WH-R. In the present embodiment, the case where the engine EN and the front motor generator FMG drive the front wheels WH-F and the rear motor generator RMG drives the rear wheels WH-R will be described, but the engine EN and the front motor generator FMG may drive the rear wheels WH-R and the rear motor generator RMG may drive the front wheels WH-F.

A transmission TM is mechanically coupled to the front wheel shafts DS-F of the front wheels WH-F via a front differential gear FDF. The engine EN and the front motor generator FMG is mechanically coupled to the transmission TM via an output power control mechanism (not shown), which controls the rotation output power combination and distribution. An alternating current side of an inverter INV is electrically connected to the stator winding of the front motor generator FMG. The inverter INV is a power converter converting direct-current power into three-phase alternating-current power and controls the driving of the motor generator MG. The direct-current side of the inverter INV is electrically connected to a battery BA.

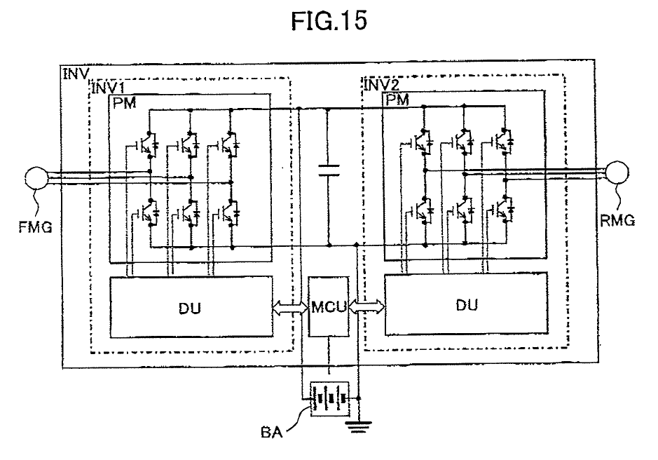

The rear motor generator RMG is mechanically coupled to the rear wheel shafts DS-R1, DS-R2 of the rear wheels WH-R via a rear differential gear RDF and a rear reduction gear RG. An alternating current side of an inverter INV is electrically connected to the stator winding of the rear motor generator RMG. The inverter INV is commonly used by the front motor generator FMG and the rear motor generator RMG and has a converter circuit for the front, motor generator FMG, a converter circuit for the rear motor generator RMG, and a drive controller for controlling them. The configuration of the inverter INV will be described later using FIG. 15.

At the start and during the low speed run (during which the operation efficiency (fuel consumption) of the engine EN is not good) of the hybrid electric vehicle, the front wheels WH-F are driven by the front motor generator FMG. In the present embodiment the case where the front wheels WH-F are driven by the front motor generator FMG at the start and during the low speed run will be described. However the rear wheels WH-R may be driven by the rear motor generator RMG while the front wheels WH-F are driven by the front motor generator FMG (a four-wheel drive run). The battery BA supplies direct-current power to the inverter INV, which converts the supplied direct-current power into three-phase alternating-current power. The three-phase alternating-current power is supplied to the stator winding of the front motor generator FMG. Thereby, the front motor generator FMG is driven to generate a rotation output power. This rotation output power is input to the transmission TM via the output power control mechanism (not shown). The input rotation output power is transmitted at a changed speed by the transmission TM to the differential gear FDF. This transmitted rotation output power is divided between the left and right by the differential gear FDF and further transmitted to the front wheel shafts DS-F1, DS-F2 respectively. The front wheel shaft DS-F1 is connected with one of the front wheels WH-F and the front wheel shaft DS-F2 is connected with the other of the front wheels WH-F. Thus the front wheels WH-F are driven through driving and rotating the front wheel shafts DS-F1, DS-F2.

During the normal run (the case where the hybrid electric vehicle runs on dry roads during which the operation efficiency (fuel consumption) of the engine EN is good) of the hybrid electric vehicle, the front wheels WH-F are driven by the engine EN. The rotation output power of the engine EN is transmitted to the transmission TM via the output power control mechanism (not shown). The transmitted rotation output power is transmitted at a changed speed by the transmission TM and transmitted via the differential gear FDF to the front wheel shafts DS-F. Thereby, the front wheels WH-F are driven to rotate. Further, the charge status of the battery BA is detected, and when the battery BA needs to be charged, part of the rotation output power of the engine EN is given to the front motor generator FMG via the output power control mechanism (not shown) to drive the front motor generator FMG to rotate. Through this operation, the front motor, generator FMG operates as an electric generator, by which three-phase alternating-current power is generated across the stator winding of the front motor generator FMC. The generated three-phase alternating-current power is converted by the inverter INV into direct-current power of predetermined voltage. The obtained direct-current power is supplied to the battery BA, thereby charging the battery BA.

During the four-wheel drive run (the case where the hybrid electric vehicle runs on such a low friction coefficient road as a snow-covered road or the like, during which the operation efficiency (fuel economy) of the engine EN is good) of the hybrid electric vehicle, the rear wheels WH-R are driven by the rear motor generator RMG while the front wheels WH-F are driven by the engine EN as in the normal run. Because the charge amount of the battery BA decreases due to the driving through the rear motor generator RMG, as in the normal run, the rotation output power of the engine EN is supplied to drive the front motor generator FMG to rotate, thereby charging the battery BA. The battery BA supplies direct-current power to the inverter INV so as for the rear motor generator RMG to drive the rear wheels WH-R. The inverter INV converts the supplied direct-current power into three-phase alternating-current power, which is supplied to the stator winding of the rear motor generator RMG. Thereby, the rear motor generator RMG is driven to generate rotation output power, which is transmitted at a reduced speed by the rear reduction gear RG to the differential gear RDF. This transmitted rotation output power is divided between the left and right by the differential gear RDF and further transmitted to the rear wheel shafts DS-R1, DS-R2 respectively. As a result, the rear wheel shafts DS-R1, DS-R2 are driven to rotate, which drives the rear wheels WH-R to rotate.

During the acceleration of the hybrid electric vehicle, the front wheels WH-F are driven by the engine EN and the front motor generator FMG. In the present embodiment the case where the front wheels WH-F are driven by the engine EN and the front motor generator FMG during the acceleration will be described. However the rear wheels WH-R may be driven by the rear motor generator RMG while the front wheels WH-F are driven by the engine EN and the front motor generator FMG (a four-wheel drive run). The rotation output power of the engine EN and the front motor generator FMG is input to the transmission TM via the output power control mechanism (not shown). The input rotation output power is transmitted at a changed speed via the differential gear FDF by the transmission TM to the front wheel shafts DS-F. Thereby, the front wheels WH-F are driven to rotate.

During the regeneration (a deceleration period such as when stepping on the brake, when putting back the accelerator, or when stopping stepping on the accelerator) of the hybrid electric vehicle, the rotation output power of the front wheels WH-F is transmitted via the front wheel shafts DS-F, the differential gear FDF, the transmission TM, and the output power control mechanism (not shown) to the front motor generator FMG, so that the front motor generator FMG is driven to rotate. Through this operation, the front motor generator FMG operates as an electric generator, by which three-phase alternating current power is produced across the stator winding of front motor generator FMG. The produced three-phase alternating-current power is converted by the inverter INV into direct-current power of predetermined voltage. The obtained direct-current power is supplied to the battery BA, thereby the battery BA is charged. Meanwhile, the rotation output power of the rear wheels WH-R is transmitted via the rear wheel shafts DS-R1, DS-R2, the differential gear RDF, and the rear reduction gear RG to the rear motor generator RMG, so that the rear motor generator RMG is driven to rotate. By this means, the rear motor generator RMG operates as an electric generator, by which three-phase alternating-current power is produced across the stator winding of the rear motor generator RMG. The produced three-phase alternating-current power is converted by the inverter INV into direct-current power of predetermined voltage. The obtained direct-current power is supplied to the battery BA, thereby charging the battery BA.

Next, the circuit configuration of the inverter INV used in an electric drive system of the hybrid electric vehicle shown in FIG. 14 will be described using FIG. 15.

The inverter INV comprises two inverters INV1, INV2. The inverters INV1, INV2 are the same in configuration. The inverters INV1, INV2 each comprises a power module PM and a driver unit DU. The driver unit DU is controlled by a motor control unit MCU. The battery BA supplies direct-current power to the power modules PM, and the inverters INV1, INV2 each convert the direct-current power into alternating-current power and supply to the motor generator. When the motor generator operates as an electric generator, the output power of the electric generator is converted by the inverters INV1, INV2 into direct-current power, which charges the battery BA.

The power module PM of the inverter INV1, INV2 comprises six arms and converts the direct-current supplied from the battery BA, which is a vehicle-mounted direct-current power supply, into an alternating current to supply electric power to the motor generators FMG, RMG. The six arms of the power module PM use an IGBT (Insulated Gate Bipolar Transistor) as a semiconductor switching element. Instead of the IGBT, a power MOS-FET (Metal Oxide Semiconductor-Field Effect Transistor) can be used as the semiconductor switching element.

The IGBT has an advantage of being quick in operation speed. In the past, because the operable voltages of power MOS-FETs were lower, high-operating-voltage inverters used IGBTs. However, recently the operable voltages of power MOS-FETs have become higher, and hence both can be used as the semiconductor switching element. The power MOS-FET is simpler in structure than the IGBT, thus having the merit that the semiconductor processes required for production are fewer than for the IGBT.

In FIG. 15, the upper and lower arms of each of the U-phase, V-phase, and W-phase are connected in series. The collector terminal (the drain terminal if power MOS-FETs are used) of the upper arm of each phase is connected to the positive electrode of the battery BA. Meanwhile, the emitter terminal (the source terminal if power MOS-FETs are used) of the lower arm of each phase is connected to the negative electrode of the battery BA.

The connection point of the emitter terminal (the source terminal for power MOS-FETs) of the U-phase upper arm and the collector terminal (the drain terminal for power MOS-FETs) of the U-phase lower arm is connected to the U-phase terminal of the motor generator FMG or RMG so that the U-phase current flows. If armature windings (stator windings for a permanent magnet synchronous motor) are in Y-connection, a U-phase winding current flows. The connection point of the emitter terminal (the source terminal for power MOS-FETs) of the V-phase upper arm and the collector terminal (the drain terminal for power MOS FETs) of the V-phase lower arm is connected to the V-phase terminal of the V-phase armature winding (stator winding) of the motor generator FMG or RMG so that the V-phase current flows. If stator windings are in Y-connection, a V-phase winding current flows. The connection point of the emitter terminal (the source terminal for power MOS-FETs) of the W-phase upper arm and the collector terminal (the drain terminal for power MOS-FETs) of the W-phase lower arm is connected to the W-phase terminal of the motor generator FMG or RMG. If stator windings are in connection, a W-phase winding current flows. The inverter converts direct-current power supplied from the battery BA into alternating-current power and supplies to the three phase stator coils, the U-phase, V-phase, and W-phase, forming the stator of the motor generator FMG or RMG, and a magnetomotive force produced by the currents flowing through the three-phase stator coils drives the rotor to rotate.

The motor control unit MCU controls the driver unit DU to generate gate signals, and the driver unit DU supplies the gate signals to the semiconductor switching elements of each phase to render each arm conductive or non-conductive (cut off). As a result, the direct current supplied is converted into a three-phase alternating current. The generation of a three-phase alternating current is already known, and hence detailed description thereof is omitted.

As described above, a vehicle provided with an electric drive system using the electrical rotation machines (motor generators) of the present invention can save space because they are smaller and higher in output power. Moreover, the electrical rotating machine of the first embodiment can contribute to making vehicles smaller, lighter, and less expensive, and in addition the improvement of fuel economy and mileage.

### Second Embodiment

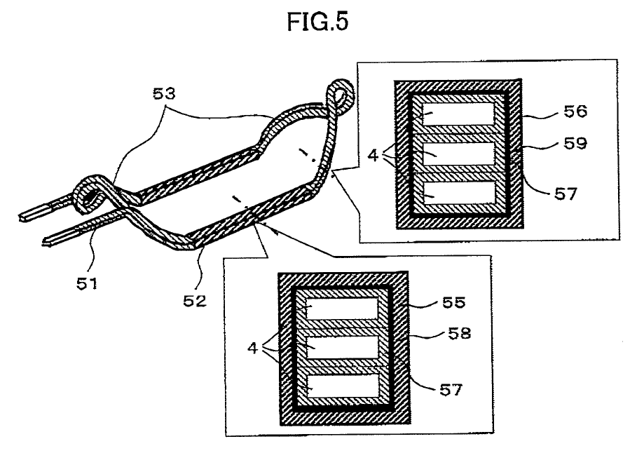

FIG. 5 shows a partial coil of an electrical rotating machine of the second embodiment. An electrical rotating machine coil 51 is made by coating a coil conductor formed by winding a wire conductor 4 on itself a predetermined number of times with an electric field lessening layer 55 or 56, and then coating slot straight portions 52 thereof with an insulation layer 58 and coil end portions 53 with an insulation layer 59. An insulation film 57 of the wire conductor 4 can be made of the same material as the insulation film 7 of the first embodiment.

Also in the second embodiment, because the insulation layers are formed before the partial coils are inserted unlike in a conventional low voltage electrical rotating machine using square shape wires, the burning of a sheet of insulation paper insulating the coil end portions or insulation failure due to failure in resin permeation does not occur. The second embodiment differs from the first embodiment in that no electric field lessening layer is formed on the insulation layers 58, 59, and hence the insulation layers 58, 59 need to be thicker than in the first embodiment. However, even in the coil end where coils are close to each other, partial discharge degradation can be prevented by appropriately determining the thickness of the insulation layer 59. Thus, according to the second embodiment there is also provided an electrical rotating machine superior in insulation property to the conventional low voltage electrical rotating machine using square shape wires, and both the rated voltage and the output power of an electrical rotating machine can be easily made higher. Moreover, because the voltage application rate between coil turns is low, a precipitous surge voltage from an inverter can be dealt with by means of only the insulation of the wire conductor or the minor addition of the insulation films.

Also in the second embodiment, the insulation layer 58 may be formed separately as in the first embodiment. As the first embodiment does, the electrical rotating machine of the second embodiment can also contribute to making vehicles smaller, lighter, and less expensive, and in addition the improvement of fuel consumption and mileage.

### Third Embodiment

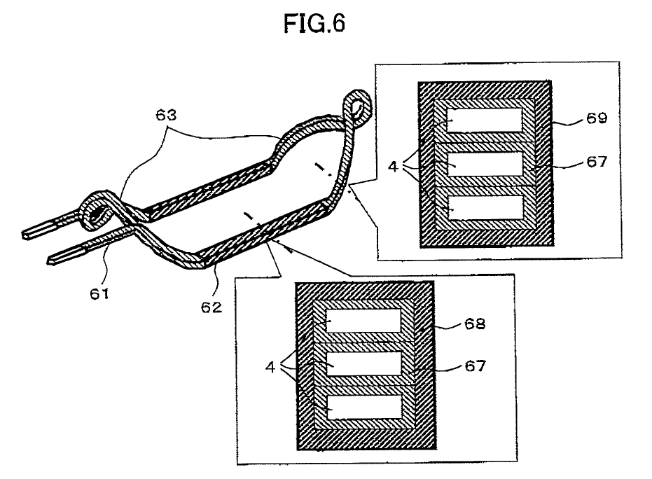

FIG. 6 shows a partial coil of an electrical rotating machine of the third embodiment. An electrical rotating machine coil 61 is made by winding a wire conductor 4 on itself a predetermined number of times to form a coil conductor and then coating slot straight portions 62 thereof with an insulation layer 68 and coil end portions 63 with an insulation layer 69. An insulation film 67 of the wire conductor 4 can be made of the same material as the insulation film 7 of the first embodiment.

Also in the third embodiment, because the insulation layers are formed before the partial coils are inserted unlike in a conventional low voltage electrical rotating machine using square shape wires, the burning of a sheet of insulation paper insulating the coil end portions or insulation failure due to failure in resin permeation does not occur. Embodiment 3 differs from the second embodiment in that no electric field lessening layer is formed on the wire conductor 4, and hence the share of an inverter surge voltage taken by the voltage between coil turns is higher than in embodiments 1 and 2. Thus, the insulation layer 67 needs to be thicker. However, if the voltage application rate between coil turns is low, the insulation capability of the third embodiment configured as above is enough. Thus, according to the third embodiment configured as above, there is also provided an electrical rotating machine superior in insulation capability to the conventional low voltage electrical rotating machine using square shape wires, and an electrical rotating machine can be easily made higher in rated voltage and output power.

Also in the third embodiment, the insulation layer 68 may be formed in steps as in the first embodiment. As the first embodiment does, the electrical rotating machine of the third embodiment can also contribute to making vehicles smaller, lighter, and less expensive, and in addition the improvement of fuel economy and mileage.

### Fourth Embodiment

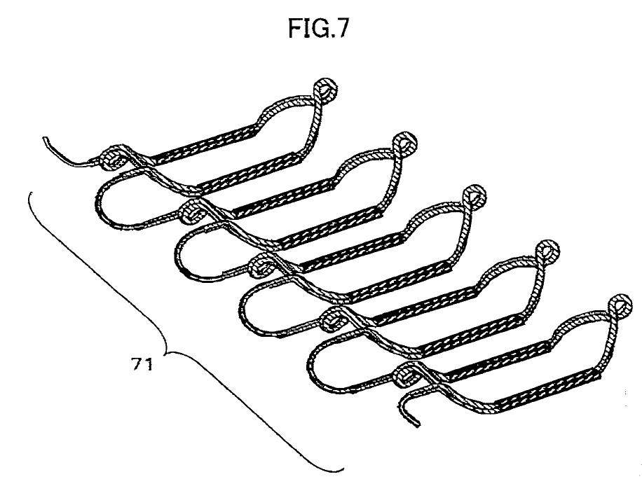

FIG. 7 shows a coil of an electrical rotating machine of the fourth embodiment. In the first to third embodiments, single partial coils are individually coated with insulation, and after mounted in the slots, the partial coils need to be connected to each other. In contrast, in the fourth embodiment, a plurality of partial coils 71 are connected beforehand and coated with insulation as in embodiments 1 to 3. Thus, connecting partial coils after mounted in the slots is not needed.

### COMPARATIVE EXAMPLE 1

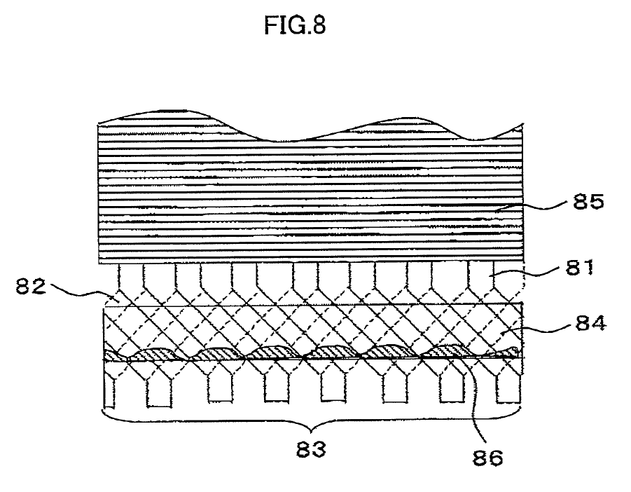

FIG. 8 shows a coil end of an electrical rotating machine of comparative example 1. In comparative example 1, after segment conductors are inserted from the inner side of a core 85, a sheet of insulation paper 84 is inserted between upper coils 81 and lower coils 82, which cross over. Thereafter, upper coils 81 and lower coils 82 are connected by welding at coil connections 83. In comparative example 1, burned parts 86 occur in the sheet of insulation paper 84, and hence insulation resistance between partial coils adjacent in the circumference direction and the radial direction decreases.

Thus, according to the present invention, there is provided an electrical rotating machine, particularly a low voltage electrical rotating machine of 600 V rms class or below using square shape wires as winding conductors, which is smaller and high in operating voltage and output power. Further, because the electrical rotating machine of the present invention is smaller and high in output power, by mounting it therein, electric vehicles with fuel economy and mileage improved over the conventional ones can be provided.

In the above embodiments, the cases of using square shape wires have been described, but not being limited to this, the present invention can be applied to cases of using round shape wires or the like.

What is claimed:

1. An electrical rotating machine comprising an insulation layer covering both a coil end portion and a slot straight portion of a coil conductor,
wherein a thickness of the insulation layer or an insulation material differs between the coil end portion and the slot straight portion.

2. An electrical rotating machine according to the claim 1, wherein the coil conductor is made of either a square shape wire or a round shape wire.

3. An electrical rotating machine according to the claim 1, wherein there is provided an electrical field lessening layer on the coil conductor.

4. An electrical rotating machine according to the claim 1, wherein there is provided an electrical field lessening layer on the insulation layer.

5. An electrical rotating machine according to the claim 1, wherein the insulation layer is formed before the coil conductor is inserted in a slot.

6. An electrical rotating machine according to the claim 1, wherein the insulation layer over the slot straight portion is separately made before the coil conductor is inserted in a slot.

7. An electrical rotating machine according to the claim 1, wherein the slot straight portion comprises a sheet of insulation paper.

8. An electrical rotating machine according to the claim 1,
wherein a partial discharge start voltage of the insulation layer over the slot straight portion is higher than a peak voltage against a to-ground voltage during an operation of the electrical rotating machine, and
wherein a dielectric breakdown voltage of the insulation layer over the slot straight portion is higher than 2E+1 of a withstand voltage test wherein E is a predetermined rated voltage.

9. An electrical rotating machine according to the claim 1,
wherein a partial discharge start voltage of the insulation layer over the coil end portion is higher than a peak voltage of a between-phase voltage during an operation of the electrical rotating machine, and
wherein a dielectric breakdown voltage of the insulation layer over the coil end portion is higher than a test voltage of an impulse withstand voltage test.

10. An electrical rotating machine according to the claim 1,
wherein a partial discharge start voltage of the insulation layer is higher than an applied voltage between turns during an operation of the electrical rotating machine, and
wherein a dielectric breakdown voltage of the insulation layer is higher than a test voltage of an impulse withstand voltage test.

11. An electrical rotating machine according to the claim 1, wherein is the electrical rotating machine is a voltage electrical rotating machines of 600 V rms class or below.

12. An electric vehicle using an electrical rotating machine according to the claim 1.

13. An electrical rotating machine according to the claim 1, wherein an electric field lessening layer is formed on the coil conductor or the insulation layer at the coil end portion.
